(19) United States
(12) Patent Application Publication
(10) Pub. No.: US 2026/0204831 A1
(43) Pub. Date: Jul. 16, 2026

(54) CAP HINGE STRUCTURE OF CHARGING CONNECTOR, AND CHARGING CONNECTOR

(71) Applicant: YAZAKI CORPORATION, Tokyo (JP)

(72) Inventors: Sho Hagita, Kakegawa-shi (JP); Atsushi Takada, Kakegawa-shi (JP)

(21) Appl. No.: 19/446,856

(22) Filed: Jan. 12, 2026

(30) Foreign Application Priority Data
Jan. 14, 2025 (JP) 2025-004624

(51) Int. Cl. H01R 13/447; B60L 53/16; H01R 13/512

(52) U.S. Cl. CPC H01R 13/447; B60L 53/16; H01R 13/512; H01R 2201/26

(57) ABSTRACT

A cap hinge structure of a charging connector includes a housing including a fitting portion provided with a front opening into which a mating charging connector can be fitted; and a cap for closing the front opening. The cap hinge structure of the charging connector further includes a body attached to the housing of the charging connector using a fastening member. The body includes a cap connection portion to which the cap is connected, and a draining path unit connected to a draining part formed in the housing of the charging connector.

### CROSS-REFERENCE TO RELATED APPLICATIONS

The present application is based on, and claims priority from the prior Japanese Patent Application No. 2025-004624, filed on January 14, 2025, the entire contents of which are incorporated herein by reference.

### TECHNICAL FIELD

The present disclosure relates to a cap hinge structure of a charging connector, and a charging connector.

### BACKGROUND

A conventionally known charging connector includes a housing including a fitting portion with a front opening into which a mating charging connector can be fitted, and a cap for closing the front opening (see JP2024-89728A). The front opening of charging connector is closed by the cap to prevent the mating charging connector from being fitted into the fitting portion when the fitting portion is not used.

### SUMMARY OF THE INVENTION

The charging connector described above includes a housing that is integral with a hinge part for connecting the cap to the housing. In the charging connector as described above, it is necessary to replace an entire housing that is integral with the hinge part when the hinge part is deformed or damaged due to an excessive force acting on the cap.

It is an object of the present disclosure to provide a cap hinge structure of a charging connector, and a charging connector, which can recover a function of a hinge part without replacing an entire housing by forming the hinge part as a component separate from a housing of the charging connector.

A cap hinge structure of a charging connector according to an embodiment includes a housing including a fitting portion provided with a front opening into which a mating charging connector can be fitted, and a cap for closing the front opening. The cap hinge structure of the charging connector further includes a body attached to the housing of the charging connector using a fastening member. The body includes a cap connection portion to which the cap is connected, and a draining path unit connected to a draining part formed in the housing of the charging connector.

The charging connector according to an embodiment includes the cap hinge structure.

The configuration described above can provide a cap hinge structure of a charging connector, and a charging connector, which can recover a function of a hinge part without replacing an entire housing by forming the hinge part as a component separate from a housing of the charging connector.

### BRIEF DESCRIPTION OF DRAWINGS

FIG. 1 illustrates a perspective view of an example of an example charging connector according to the present embodiment.

FIG. 2 is an exploded perspective view of a charging connector according to the present embodiment.

FIG. 3 is a front view of the charging connector before the cap is attached.

FIG. 4 is a sectional view taken along line A-A in FIG. 3.

FIG. 5 is a perspective rear view of a hinge component.

### DETAILED DESCRIPTION OF THE INVENTION

Hereinafter, a cap hinge structure of a charging connector, and a charging connector, according to the present embodiment will be described in detail with reference to the drawings. It should be noted that the dimensional ratios in the drawings are exaggerated for convenience of explanation, and may be different from the actual ratios.

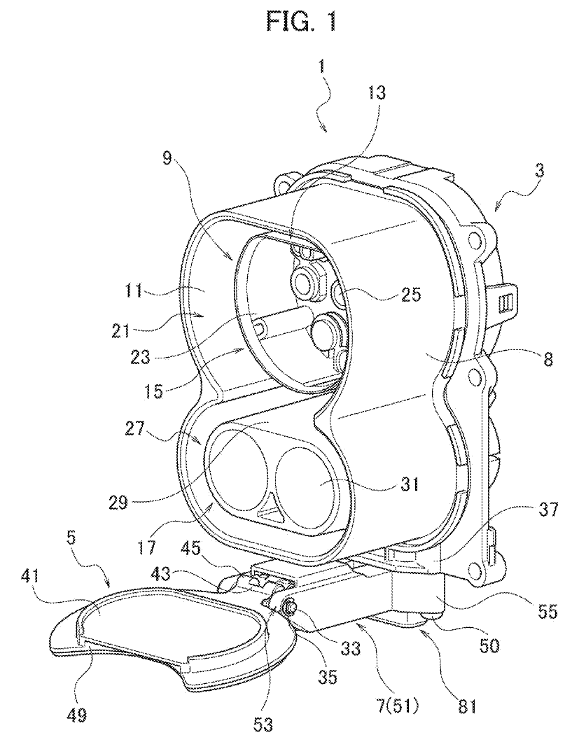

As illustrated in FIG. 1, the charging connector 1 according to the present embodiment is applied to a vehicle charging unit provided in a vehicle, such as an electric vehicle or a hybrid vehicle, for example. The charging connector 1, also referred to as a charging inlet, is electrically connected to a power supply (not illustrated), such as a battery or a storage battery mounted in the vehicle. The charging connector 1 is engaged with a mating charging connector (not illustrated) provided in a power supply facility to charge the power supply.

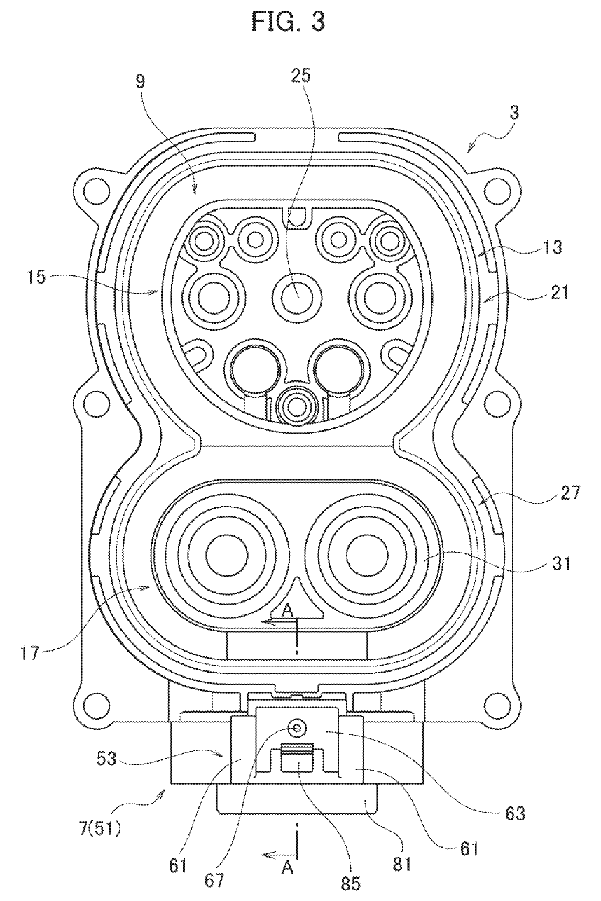

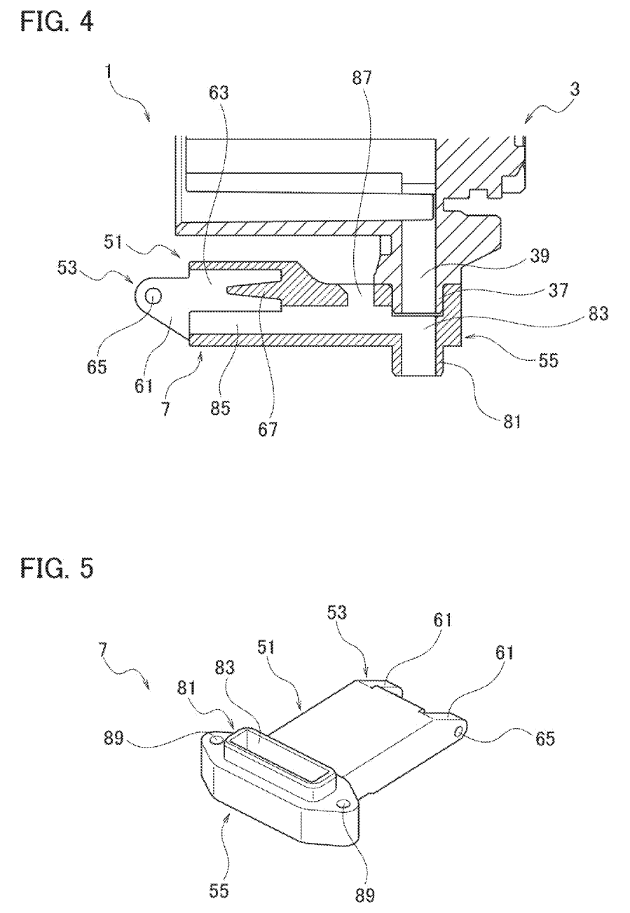

As illustrated in FIGS. 1 to 5, the charging connector 1 includes a housing 3, a cap 5, and a hinge component 7 as a cap hinge structure.

As illustrated in FIGS. 1 to 3, the housing 3 is made of an insulation material such as a synthetic resin. The housing 3 is provided with an outer wall 8 extending in a cylindrical shape in the direction of fitting with the mating charging connector. A fitting portion 9 into which a mating charging connector can be fitted is provided inside the outer wall 8. The fitting portion 9 includes a fitting outer wall 11 extending in a cylindrical shape in a direction in which the fitting portion 9 is fitted with the mating charging connector. An opening of the fitting outer wall 11 on a fitting surface side thereof constitutes a front opening 13 into which the mating charging connector is inserted.

The mating charging connector includes a normal charging connector (not illustrated) for charging a power supply within a normal time, and a quick charging connector (not illustrated) for charging a power source within a short time. Therefore, the interior of the fitting outer wall 11 of the housing 3 is divided into a normal fitting portion 15 which can be fitted with the normal charging connector, and a quick fitting portion 17 which can be fitted with the quick charging connector.

The normal fitting portion 15 is arranged in an upper part inside the fitting outer wall 11. The front opening 13 of the normal fitting portion 15 constitutes a normal front opening 21 into which the normal charging connector can be inserted. A normal inner wall 23 is formed inside the normal fitting portion 15, extending in a cylindrical shape in the direction of fitting with the normal charging connector. A plurality of normal terminal reception chambers 25 (seven normal terminal reception chambers 25 in the present embodiment) are formed in the normal inner wall 23, extending in a cylindrical shape in the direction of fitting with the normal charging connector. Both sides of the normal terminal reception chambers 25 in a longitudinal direction are open. An opening of the normal terminal reception chamber 25 on one side in the longitudinal direction constitutes a connection opening into which a mating terminal (not illustrated) of the normal charging connector is inserted when the normal charging connector is fitted into the normal fitting portion 15. An opening of the normal terminal reception chamber 25 on the other side in the longitudinal direction constitutes an insertion opening through which a normal charging terminal (not illustrated) can be inserted into the normal terminal reception chamber 25. Charging terminals are received in the plurality of normal terminal reception chambers 25 each through the insertion openings.

The normal charging terminal is electrically connected to a terminal portion of an electric wire (not illustrated) electrically connected to a power supply. The normal charging terminal is electrically connected to a mating terminal of the normal charging connector by fitting the normal charging connector into the normal fitting portion 15. The power supply is charged from the power supply facility within a normal time using the electrical connection between the normal charging terminal and the mating terminal.

The quick fitting portion 17 is arranged on a lower part inside the fitting outer wall 11. The front opening 13 of the quick fitting portion 17 constitutes a quick front opening 27 into which the quick charging connector can be inserted. A quick inner wall 29 is formed inside the quick fitting portion 17, extending in a cylindrical shape in the direction of fitting with the quick charging connector. A plurality of quick terminal reception chambers 31 (two quick terminal reception chambers 31 in the present embodiment) are formed inside the quick inner wall 29, extending in a cylindrical shape in the direction of fitting with the quick charging connector. Both sides of the quick terminal reception chambers 31 in a longitudinal direction are open. An opening of the quick terminal reception chamber 31 on one side in the longitudinal direction constitutes a connection opening into which a mating terminal (not illustrated) of the quick charging connector is inserted when the quick fitting portion 17 is fitted with the quick charging connector. An opening of the quick terminal reception chamber 31 on the other side in the longitudinal direction constitutes an insertion opening through which a quick charging terminal (not illustrated) can be inserted into the quick terminal reception chamber 31. Quick charging terminals are received in the plurality of quick terminal reception chambers 31 each through the insertion openings.

The quick charging terminals are electrically connected to a terminal portion of an electric wire (not illustrated) electrically connected to a power supply. The quick charging terminals are electrically connected to the mating terminals of the quick charging connector by fitting the quick charging connector to the quick fitting portion 17. The power supply is charged from the power supply facility within a short time using the electrical connection between the quick charging terminal and the mating terminal.

A draining part 37 is formed in the housing 3. The draining part 37 is formed in a cylindrical shape, extending in a height direction of the housing 3, and a housing side draining path 39 for discharging moisture entering the inside of the housing 3 is formed inside the draining part 37.

The charging connector 1 including the normal fitting portion 15 and the quick fitting portion 17 in the housing 3 may not use the quick fitting portion 17, for example, when the charging connector 1 is applied to a vehicle on which no large capacity power supply is mounted. Therefore, the quick front opening 27 of the quick fitting portion 17 is closed by the cap 5.

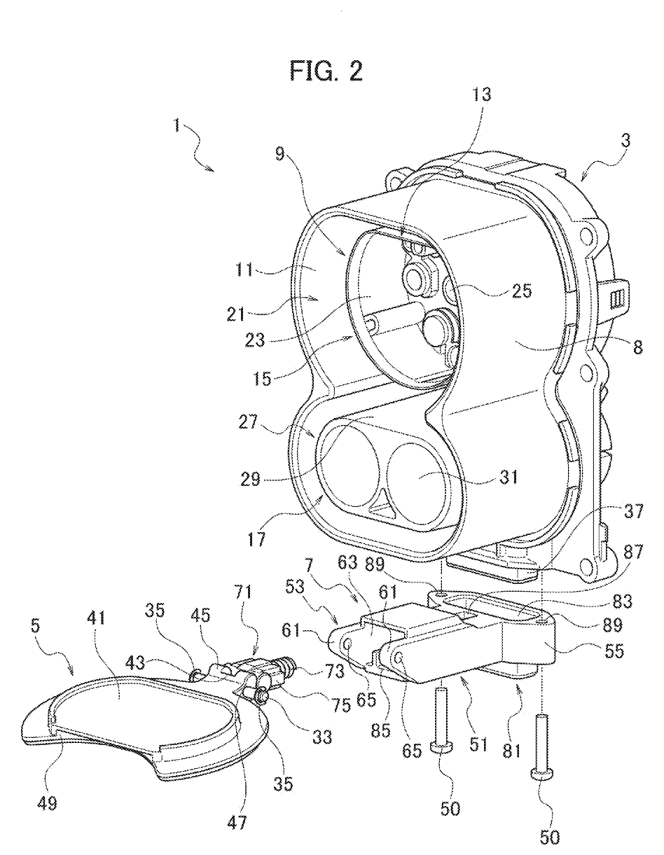

As illustrated in FIGS. 1 and 2, the cap 5 is made of, for example, an insulation material such as a synthetic resin. The cap 5 includes a plate-like cap body 41 and a shaft support 43 integral with the cap body 41. For example, a grip 49 for a user to grip the cap 5 is provided on a front surface of the cap body 41. The shaft support 43 has a cylindrical shape and extends in a lateral direction. A cam surface 45 is formed around an axial center of the shaft support 43 on an outer surface of the shaft support 43 opposite the side where the cap body 41 is provided. A shaft hole 47 through which a shaft support pin 33 (described below) is inserted is provided in an axial center direction of the shaft support 43 (see FIG. 2). The shaft support 43 is rotatably attached to a support portion 61 (described below) to open and close the quick front opening 27 of the quick fitting portion 17.

As illustrated in FIGS. 1 to 5, the hinge component 7 is made of, for example, an insulation material such as a synthetic resin. The hinge component 7 includes a body 51 that is attached to the housing 3 of the charging connector 1 using a fastening member (for example, a bolt 50). The body 51 includes a cap connection portion 53 to which the cap 5 is connected, and a draining path unit 81 connected to the draining part 37 formed in the housing 3 of the charging connector 1. In the present embodiment, the draining path unit 81 includes a first draining path 83 communicating with the housing side draining path 39 of the housing 3, a second drain path 85 communicating with the inside of a receiver 63, and a third draining path 87 opening to an upper surface of the body 51. The draining path unit 81 includes a cylindrical portion 55 extending in the height direction of the housing 3, and the cylindrical portion 55 is fitted (engaged) with the draining part 37 in a cylindrical shape in the housing 3. The body 51 includes a through hole 89 through which the bolt 50 is inserted.

The cap connection portion 53 includes a pair of support portions 61 for supporting the shaft support pin 33 and the receiver 63 recessed between the pair of supporting portions 61. Each of the pair of supporting portions 61 includes a shaft support hole 65 through which the shaft support pin 33 is inserted. The shaft support pin 33 inserted into the shaft support holes 65 of the pair of supporting portions 61 is secured against slipping by retaining rings 35 fitted onto both ends.

As illustrated in FIGS. 1 and 2, a follower 71 is received in the receiver 63. The follower 71 includes a biasing member (spring 73) and a follower cam (spring holder 75) biased by the spring 73 in the direction of abutting the cam surface 45 of the shaft support 43. A holding portion 67 to which the spring 73 is attached to be held is formed inside the receiver 63 (see FIG. 24). The spring holder 75 attached to a tip of the spring 73 follows rotation of the cap 5 while a tip of the spring holder 75 elastically contacts the shaft support 43 due to an elastic restoring force of the spring 73 received in the receiver 63.

In the charging connector 1 according to the present embodiment, the hinge component 7 formed as a component (structure) separate from the housing 3 serves as a hinge part (cap connection portion 53) for assembling components, such as the cap 5 and the shaft support pin 33. By forming the hinge component 7 as a component separate from the housing 3, the function of the hinge part (cap connection portion 53) can be recovered only by replacing the hinge component 7 even if the hinge part (cap connection portion 53) is deformed or damaged due to excessive force acting on the cap 5. Therefore, replacement of the housing 3 is unnecessary, and a maintenance cost can be reduced.

The cap hinge structure (hinge component 7) according to the present embodiment include the body 51 which is attached to the housing 3 of the charging connector 1. Therefore, the hinge part 7 is attached to the housing of an existing charging connector, so that the cap 5 can be added to the charging connector. Furthermore, the charging connector 1 includes the draining path unit 81 connected to the draining part 37 formed in the housing 3 of the charging connector 1. Therefore, the cap 5 can be added to the charging connector without the function of the draining part included in the housing of the existing charging connector being impaired.

In a conventional general charging inlet, a cap is held by a hinge part integral with a housing, and the hinge part needs to be made of the same material as the housing. In the charging connector 1 according to the present embodiment, the hinge component 7, which is a component separate from the housing 3, serves as a hinge part is, so that it is possible to use a material different from the housing 3 for the hinge component 7. For example, effective measures against cracking can be taken when a sticky resin is used for the hinge component 7. In addition, a material that is strong against a load from the shaft support pin 33, a material that gives the shaft support pin 33 a good sliding properties, or the like, can be used for the hinge component 7. Furthermore, the material of the hinge part 7 can be changed to a material that is easy to replace, so that the value as an aftermarket part is enhanced.

As described above, the charging connector 1 according to the present embodiment includes the housing 3 including the fitting portion (quick fitting portion 17) provided with the front opening (quick front opening 27) into which a mating charging connector can be fitted, and the cap 5 for closing the front opening (quick front opening 27). The cap hinge structure (hinge component 7) of the charging connector 1 further includes the body 51 attached to the housing 3 of the charging connector 1 by the fastening member (bolt 50). The body 51 includes the cap connection portion 53 to which the cap 5 is connected, and the draining path unit 81 connected to the draining part 37 formed in the housing 3 of the charging connector 1.

In the present embodiment, the cap hinge structure (hinge component 7) is a component (structure) separate from the housing 3. Thus, the function of the hinge part (cap connection portion 53) can be recovered only by replacing the hinge component 7 even if the hinge part (cap connection portion 53) is deformed or damaged due to excessive force acting on the cap 5. Therefore, replacement of an entire housing 3 is unnecessary, and a maintenance cost can be reduced.

According to the present embodiment, it is possible to provide a cap hinge structure of the charging connector 1, which can recover the function of the hinge part without replacing the entire housing 3 by making the hinge part as a component separate from the housing 3 of the charging connector 1.

In the cap hinge structure (hinge component 7) of the charging connector 1, the body 51 may include a through hole 89 through which the fastening member (bolt 50) is inserted.

According to the present embodiment, the body 51 of the hinge component 7 includes the through hole 89, so that it is possible to improve the attachment of the hinge component 7 (body 51) to the housing 3.

Further, the charging connector 1 according to the present embodiment includes the cap hinge structure (hinge component 7) described above.

In the present embodiment, the hinge part (cap connection portion 53) is a component (structure) separate from the housing 3. Thus, the function of the hinge part (cap connection portion 53) can be recovered only by replacing the hinge component 7 even if the hinge part (cap connection portion 53) is deformed or damaged due to excessive force acting on the cap 5. Therefore, replacement of the entire housing 3 is unnecessary, and a maintenance cost can be reduced.

According to the present embodiment, it is possible to provide the charging connector 1 which can recover the function of the hinge part without replacing the entire housing 3 by forming the hinge part as a component separate from the housing 3 of the charging connector 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A cap hinge structure of a charging connector comprising:
a housing including a fitting portion provided with a front opening into which a mating charging connector can be fitted; and
a cap for closing the front opening, wherein
the cap hinge structure of the charging connector further comprises a body attached to the housing of the charging connector using a fastening member, and
the body includes a cap connection portion to which the cap is connected, and a draining path unit connected to a draining part formed in the housing of the charging connector.

2. The cap hinge structure of the charging connector according to claim 1, wherein the body includes a through hole through which the fastening member is inserted.

3. A charging connector comprising the cap hinge structure according to claim 1.
